(19) United States
(12) Patent Application Publication
(10) Pub. No.: US 2016/0191730 A1
(43) Pub. Date: Jun. 30, 2016

(54) IMAGE PROCESSING APPARATUS

(71) Applicant: Konica Minolta, Inc., Tokyo (JP)

(72) Inventors: Tsutomu OHATA, Toyokawa-shi (JP); Hisataka FUNAKAWA, Okazaki-shi (JP)

(73) Assignee: Konica Minolta, Inc., Tokyo (JP)

(21) Appl. No.: 14/980,723

(22) Filed: Dec. 28, 2015

(30) Foreign Application Priority Data
Dec. 29, 2014 (JP) 2014-266994

(51) Int. Cl. H04N 1/00

(52) U.S. Cl. CPC H04N 1/00307; H04N 1/00129; H04N 1/00411

(57) ABSTRACT

An image processing apparatus is provided that is capable of conducting short-range wireless communication with a terminal having a first display unit. The image processing apparatus includes an operation panel including a second display unit, and a sensor configured to sense a radio wave from the terminal for short-range wireless communication. The operation panel is capable of changing a position thereof relative to a main body of the image processing apparatus. The operation panel includes a touch area arranged on the operation panel, wherein the touch area is an area where the terminal is sensed by the sensor.

This application is based on Japanese Patent Application No. 2014-266994 filed with the Japan Patent Office on Dec. 29, 2014, the entire content of which is hereby incorporated by reference.

### BACKGROUND OF THE INVENTION

1. Field of the invention

The present disclosure relates to an image processing apparatus, and particularly to an image processing apparatus that conducts short-range wireless communication with an information terminal.

2. Description of the Related Art

In recent years, some terminal devices such as smart phones and tablet terminals are equipped with a function that conducts short-range wireless communication, for example, near field communication (NFC). In this case, a user can conduct data communication using such a terminal device by waving the terminal device over a predetermined position of a device with which the terminal device is communicating. Some image processing apparatuses such as multi-functional peripherals (MFPs) have also been proposed which can conduct short-range wireless communication with a terminal device.

An image processing apparatus that conducts short-range wireless communication with a terminal device is disclosed in Japanese Laid-Open Patent Publication No. 2010-114784, for example. This image processing apparatus is provided with a reading panel, which is spaced from an operation panel for displaying operation information, and includes a mounting surface for reading the information over short-range wireless communication.

Japanese Laid-Open Patent Publication No. 2014-120915 discloses a communication system including a terminal and a communication apparatus. In this communication system, a first type of wireless communication (NFC) is used to establish a second type of wireless communication (WiFi®: Wireless Fidelity) connection. Data on the terminal side is then printed by the communication apparatus. In this system, a series of operations in the flow is displayed on display units of both the terminal and the communication apparatus.

Japanese Laid-Open Patent Publication No. 2009-216866 discloses a video display apparatus equipped with a flat display-type display panel. This video display apparatus includes, on a rear surface of the display panel, an antenna for short-range wireless communication which is approximately the same in size as the display panel.

With the image processing apparatus that conducts short-range wireless communication with a terminal device, a user needs to simultaneously check the contents displayed on both the operation panel on the image processing apparatus side and the display device on the terminal device side. In the image processing apparatus, the position of the operation panel (height, angle, etc.) may be changed in accordance with the user's state.

However, in the case where the reading panel is spaced from the operation panel in the image processing apparatus as disclosed in Japanese Laid-Open Patent Publication No. 2010-114784, the user needs to take a troublesome action in order to simultaneously check a display on the operation panel side and a display on the terminal device side. One example of such a troublesome action is for the user to turn his/her eyes to both the displays. Another example thereof is for the user to change the position of at least one of the operation panel and the reading panel. Furthermore, if the position of the reading panel is changed in accordance with the position of the operation panel, and then the position of the operation panel is changed, the user needs to take a troublesome action, that is, to change the position of the reading panel again in accordance with the changed position of the operation panel.

The present disclosure was invented in view of the actual circumstances described above, and an object thereof is to allow a user to simultaneously check both a display of an operation panel of an image processing apparatus and a display of a terminal device, without the need for a troublesome action.

### SUMMARY OF THE INVENTION

According to one aspect of the present disclosure, an image processing apparatus is provided that is capable of conducting short-range wireless communication with a terminal having a first display unit. The image processing apparatus includes an operation panel including a second display unit, and a sensor configured to sense a radio wave from the terminal for short-range wireless communication. The operation panel is capable of changing a position thereof relative to a main body of the image processing apparatus. The operation panel includes a touch area arranged on the operation panel, wherein the touch area is an area where the terminal is sensed by the sensor.

According to another aspect of the present disclosure, an image processing apparatus is provided that is capable of conducting short-range wireless communication with a terminal. The image processing apparatus includes an operation panel including a display unit and removable from a main body of the image processing apparatus, and a sensor configured to sense a radio wave from the terminal for short-range wireless communication. The operation panel is capable of changing a position thereof relative to a main body of the image processing apparatus. The operation panel includes a touch area arranged on the operation panel, wherein the touch area is an area where the terminal is sensed by the sensor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an overall configuration of an MFP.

FIG. 2 is a diagram for explaining change in the position of the operation panel.

FIG. 3 is a diagram for explaining change in the position of the operation panel.

FIG. 4 is a diagram for explaining change in the position of the operation panel.

FIG. 5 is a diagram showing an external appearance of the operation panel.

FIG. 6 is a diagram showing a state in which a mobile terminal and the MFP are conducting short-range wireless communication.

FIG. 7 is a block diagram showing a hardware configuration of the MFP.

FIG. 8 is a diagram showing a hardware configuration of a portion of the operation panel that processes input to the touch sensor.

FIG. 9 is a diagram showing one exemplary hardware configuration of the mobile terminal, which is one example with which the MFP communicates over short-range wireless communication.

FIG. 10 is a diagram for explaining one example of change in contents displayed on a display unit.

FIG. 11 is a diagram showing one exemplary positional relationship between a touch area and a start button in the operation panel according to a first embodiment.

FIG. 12 is a diagram showing another exemplary positional relationship between the touch area and the start button in the operation panel.

FIG. 13 is a diagram for explaining a first modification of the operation panel according to the first embodiment.

FIG. 14 is a diagram for explaining a second modification of the operation panel according to the first embodiment.

FIG. 15 is a plan view of the operation panel.

FIG. 16 is a diagram schematically showing a cross section of the operation panel.

FIG. 17 is a diagram for explaining change in the position of the operation panel in an MFP according to a second embodiment.

FIG. 18 is a diagram for explaining change in the position of the operation panel in an MFP according to a third embodiment.

### DESCRIPTION OF THE PREFERRED EMBODIMENTS

Embodiments of the image processing apparatus will be hereinafter described with reference to the drawings. In the following description, identical parts and components are labeled with identical signs. These parts and components are also identical in name and function. Thus, the description thereof will not be repeated.

### First Embodiment

### 1. Summary

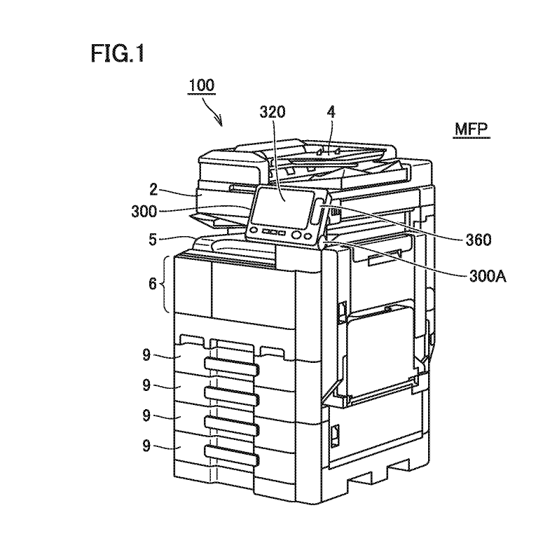

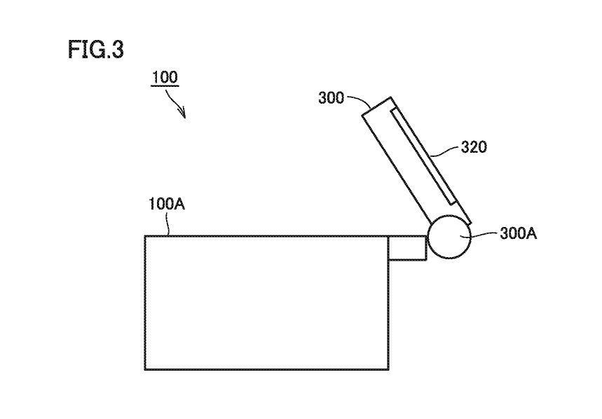

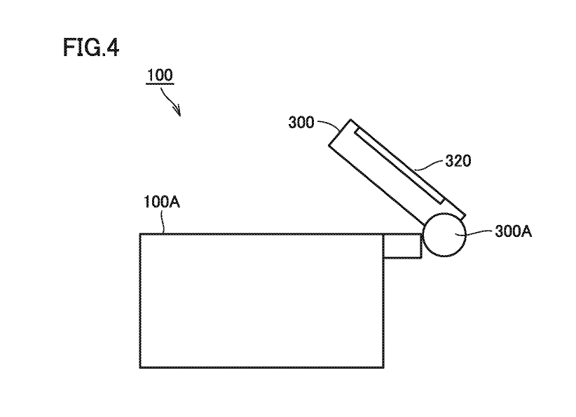

Referring to FIGS. 1 to 6, a summary of the configuration of an MFP will be described as a first embodiment of an image processing apparatus.

Referring to FIG. 1, an overall configuration of an MFP 100 will be described.

MFP 100 in FIG. 1 includes a scanner unit 2 that optically reads a document to obtain image data, and a printing unit 6 that prints an image on a sheet based on the image data. A feeder 4 for delivering the document to scanner unit 2 is arranged on an upper face of a main body of image forming apparatus MFP 100. A plurality of paper feed units 9 for feeding sheets to printing unit 6 are placed on lower portions of MFP 100. A tray 5 for ejection of the sheet having the image formed thereon by printing unit 6 is arranged on a central portion of MFP 100.

In MFP 100, operation panel 300 is attached to a front face side of an upper portion of the main body of MFP 100. The term “front face” as used herein refers to the face of MFP 100 opposed to the user who uses MFP 100. Operation panel 300 is substantially plate-shaped in external shape. In MFP 100, operation panel 300 is provided to be capable of changing its position. In the first embodiment, operation panel 300 changes its position when an angle of inclination of a main face thereof with respect to a vertical direction is changed. In response to the change in position, operation panel 300 displays information at an angle corresponding to a user's state (for example, the user's height or the user sitting on a wheelchair).

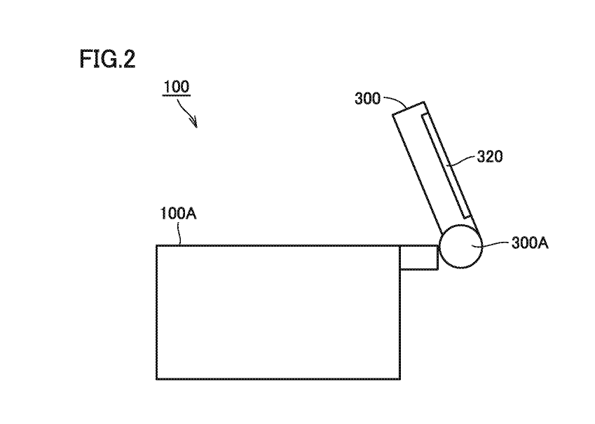

Referring to FIGS. 2 to 4, change in the position of operation panel 300 will be described. The angle of inclination of the main face of operation panel 300 with respect to the vertical direction is changed in the order shown in FIGS. 2, 3, and 4. More specifically, a hinge 300A is provided at a lower end of operation panel 300. Operation panel 300 rotates about hinge 300A, such that the angle of its main face is changed, thereby changing its position.

### 2. External Appearance of Operation Panel

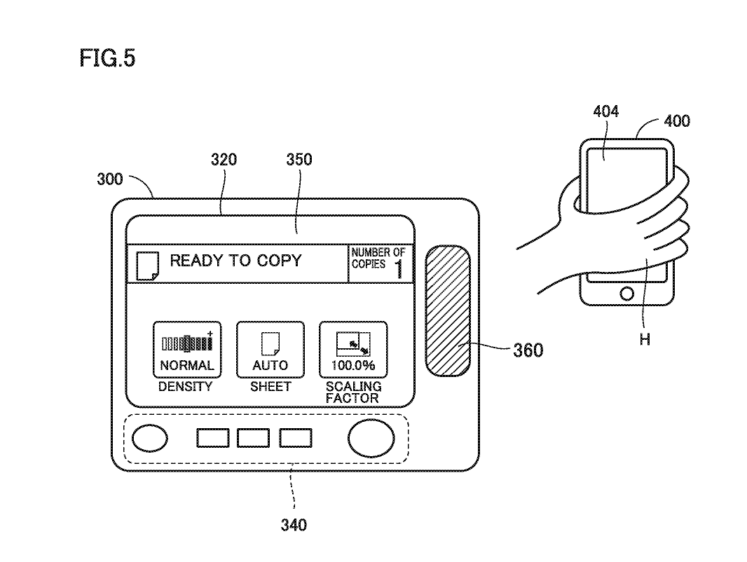

Referring to FIG. 5, an external appearance of operation panel 300 will be described.

As shown in FIG. 5, operation panel 300 includes a display unit 320, a touch sensor 350, and a button group 340 constituted of a plurality of buttons. Display unit 320 displays positions of software keys. A touch in a position corresponding to a software key displayed on display unit 320 on touch sensor 350 causes MFP 100 to execute an operation in accordance with the key corresponding to the touched position. MFP 100 executes an operation in accordance with input to touch sensor 350 other than a touch on a key. Display unit 320 displays various items of information including a state of MFP 100, in addition to the positions of the software keys.

Button group 340 includes buttons for receiving input of various instructions from the user, and buttons for receiving input of information such as numbers, letters, and symbols. More specifically, button group 340 includes a start button for initiating an operation such as copy/scan, a stop button for instructing to stop the copy/scan operation, and a reset button for canceling a set mode or job. In operation panel 300, button group 340 is arranged adjacent to a lower side of display unit 320.

The direction of display unit 320 is specified with reference to, for example, a state in which information displayed on display unit 320 is in an upright state when display unit 320 is displaying the information In FIG. 5, information including the letter string “READY TO COPY” is displayed.

A housing of operation panel 300 includes a touch area 360, which is set as a region for indicating a position over which a terminal (mobile terminal 400 in FIG. 5) for communicating with MFP 100 over short-range wireless communication is to he waved. Touch area 360 is shown, for example, as a frame printed on the housing of operation panel 300. As used herein, the “touch area” is not necessarily limited to an area with which the terminal is to be brought into contact, but may be any area for the terminal to face contactlessly in proximity thereto, that is, an area over which the terminal is to be waved. In MFP 100, an antenna for conducting short-range wireless communication (short-range communication unit 380 described below) is contained in operation panel 300. The antenna is arranged on a rear side of touch area 360 in operation panel 300.

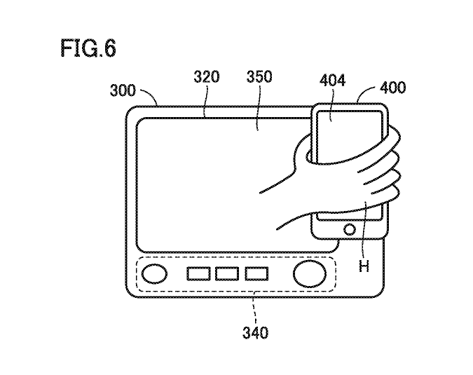

Referring further to FIG. 6, short-range wireless communication between mobile terminal 400 and MFP 100 will be described. In FIGS. 5 and 6, a user's hand holding mobile terminal 400 is shown as a hand H. Mobile terminal 400 has a display unit 404. Touch area 360 is arranged adjacent to display unit 320. As shown in FIG. 6, the user waves mobile terminal 400 over touch area 360. This allows mobile terminal 400 to communicate with MFP 100 while the user is viewing both of display unit 320 of operation panel 300 and display unit 404 of mobile terminal 400.

### Hardware Configuration of MFP

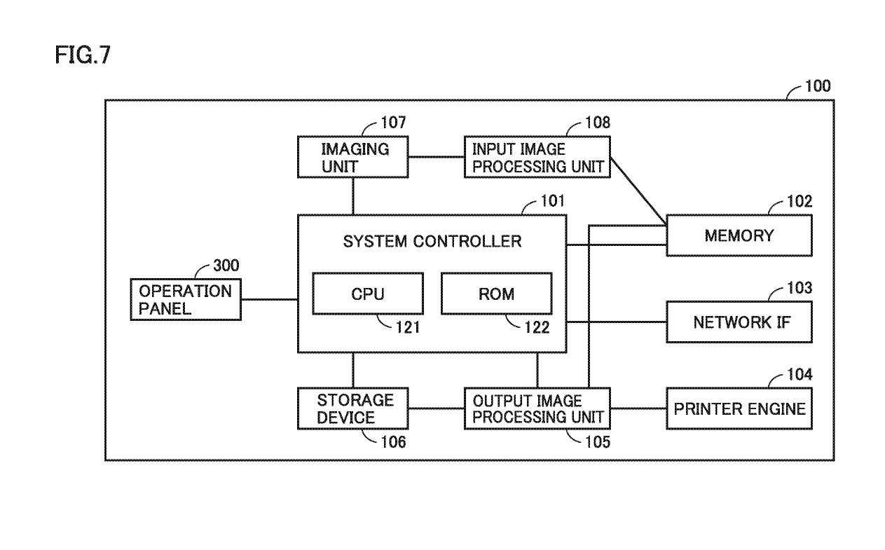

Referring to FIG. 7, a hardware configuration of MFP 100 will be described.

As shown in FIG. 7, MFP 100 includes a system controller 101, a memory 102, a network interface (I/F) 103, a printer engine 104, an output image processing unit 105, a storage device 106, an imaging unit 107, an input image processing unit 108, and operation panel 300. System controller 101 is connected, via an internal bus, for example, to memory 102, network interface 103, printer engine 104, output image processing unit 105, storage device 106, imaging unit 107, input image processing unit 108, and operation panel 300.

System controller 101 controls MFP 100 as a whole with respect to various jobs such as a scan job, a copy job, a mail transmission job, and a print job. System controller 101 includes a CPU (Central Processing Unit) 121 and a ROM (Read Only Memory) 122.

CPU 121 executes a control program stored in ROM 122. ROM 122 stores various programs for controlling the operation of MFP 100 and various types of fixed data. CPU 121 reads and writes data from and to memory 102.

Memory 102, which is a RAM (Random Access Memory), for example, is used for temporarily storing image data or data required for CPU 121 to execute the control program, for example.

Network interface 103 communicates with an external device over a network in accordance with an instruction from system controller 101.

Printer engine 104 performs print processing on a sheet or the like based on print data processed by output image processing unit 105. In particular, where MFP 100 operates as a printer, printer engine 104 prints an image, and where MFP 100 operates as a copying machine, printer engine 104 prints an image read by imaging unit 107.

Output image processing unit 105, during printing of an image, for example, converts the data format of the image into a data format for printing.

Storage device 106, which is a hard disk drive (HDD), for example, stores data concerning the operation of MFP 100. Storage device 106 may also store image data for a screen to be displayed on operation panel 300 of MFP 100.

Imaging unit 107 reads an image of the document, and outputs the image to input image processing unit 108.

Input image processing unit 108 converts the format of the image data when an image is read by imaging unit 107.

The operation of MFP 100 as described herein is realized by CPU 121 executing an appropriate program. The program to be executed by CPU 121 may be stored in ROM 122 as described above, may be stored in storage device 106, or may be stored in a storage medium removable from MFP 100.

### Configuration of Operation Panel

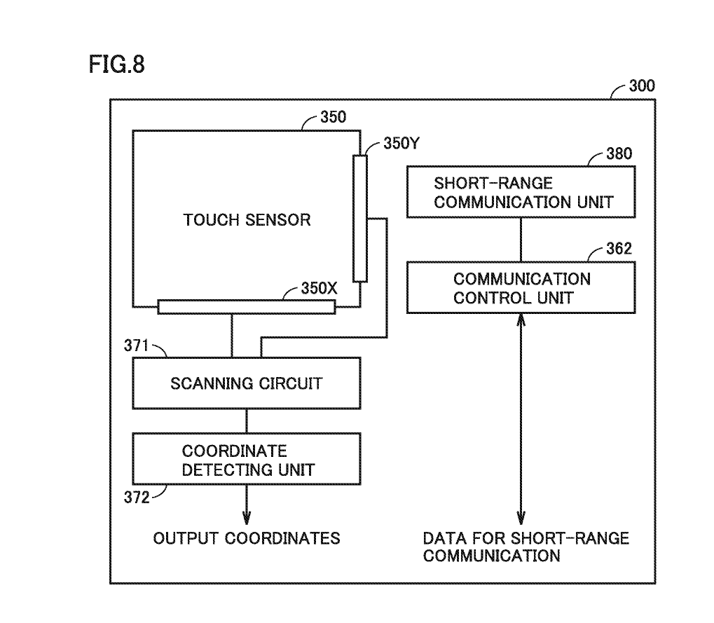

Referring to FIG. 8, a hardware configuration of a portion of operation panel 300 that processes input to touch sensor 350 will be described.

Touch sensor 350 includes a plurality of electrodes arranged in a matrix form. Electrodes arranged to extend in an X-axis direction of touch sensor 350 are shown as an X electrode group 350 X, and electrodes arranged to extend in a Y-axis direction are shown as a Y electrode group 350Y.

X electrode group 350X and Y electrode group 350Y are connected to a scanning circuit 371. Scanning circuit 371 successively scans voltage values of respective X electrode group 350X and Y electrode group 350Y to specify an amount of change in the capacitance of touch sensor 350, caused by a touch of an electrical conductor on the surface of touch sensor 350 of each of the electrodes. Scanning circuit 371 outputs the specified amount of change in capacitance to a coordinate detecting unit 372.

Coordinate detecting unit 372 specifies a touch position in touch sensor 350, based on the amount of change input from scanning circuit 371. Coordinate detecting unit 372 then outputs to a system controller 101 the presence of a touch operation in the specified touch position.

Operation panel 300 includes a short-range communication unit 380 and a communication control unit 382 for transmitting and receiving information over short-range wireless communication. Communication control unit 382 is implemented by a communication circuit for short-range wireless communication, for example. Short-range communication unit 380 is implemented by an antenna for short-range wireless communication, for example. Communication control unit 382 converts radio waves received by short-range communication unit 380 into a signal, and transmits the signal to system controller 101

### Hardware Configuration of Mobile Terminal

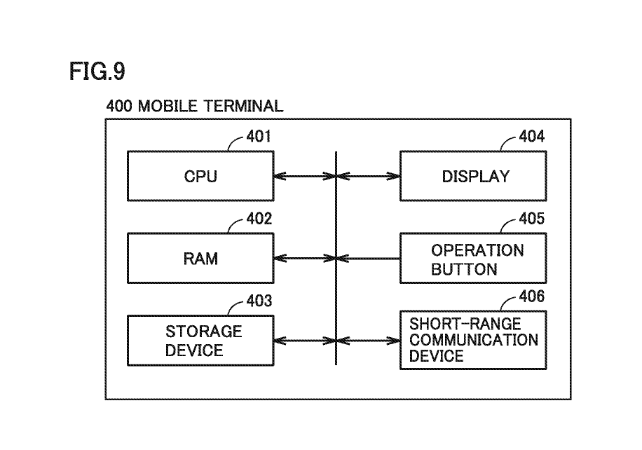

Referring to FIG. 9, an exemplary hardware configuration of mobile terminal 400, which is one example with which MFP 100 communicates over short-range wireless communication, will be described.

Mobile terminal 400 includes, as main components, a CPU 401, a RAM 402, a storage device 403, a display unit 404, an operation button 405, and a short-range communication device 406 CPU 401, RAM 402, storage device 403, display unit 404, operation button 405, and short-range communication device 406 are connected to one another with an internal bus.

CPU 401 is an exemplary arithmetic unit that executes processing for controlling overall operation of mobile terminal 400.

RAM 402 serves as a work area during the execution of processing by CPU 401.

Storage device 403 stores data of various programs such as operation system (OS) programs or application programs executed by CPU 401, as well as data used for the execution of these programs. Storage device 403 may be a medium storing data in a non-volatile manner, such as an electrically erasable programmable read-only memory (EEPROM), for example. A program downloaded over the network may also be installed onto storage device 403.

Display unit 404 is a display unit for displaying an image representing a result of processing by a program executed by CPU 401.

Operation button 405 is an exemplary input device through which information is input to mobile terminal 400, such as an instruction concerning the processing of a running application. Note that a touch sensor provided on display unit 404 may be mentioned as another example of the input device included in mobile terminal 400.

Short-range communication device 406 is an exemplary communication device for communicating information with an external device such as MFP 100 in accordance with a standard, for example, NFC.

### Arrangement of Touch Area 360

### Two Displays Are Simultaneously Visible

Referring mainly to FIGS. 5 and 6, an arrangement of touch area 360 in MFP 100 according to the first embodiment will be described.

In MFP 100, operation panel 300 contains an antenna for short-range wireless communication (short-range communication unit 380 (FIG. 8)), such that touch area 360 is arranged on operation panel 300. That is, display unit 320 and touch area 360 are arranged on the same housing. This allows a user to visually recognize display unit 320 and touch area 360 simultaneously.

When the position of operation panel 300 is changed, the position of touch area 360 is changed in conjunction with the position of display unit 320. Thus, the user who conducts short-range wireless communication by waving mobile terminal 400 over touch area 360 can visually recognize display unit 320 and touch area 360 simultaneously, without the need for an action to adjust the position of touch area 360 in accordance with the position of display unit 320. Because display unit 320 and touch area 360 are simultaneously visible, display unit 320 and display unit 404 of mobile terminal 400 waved over touch area 360 become simultaneously visible.

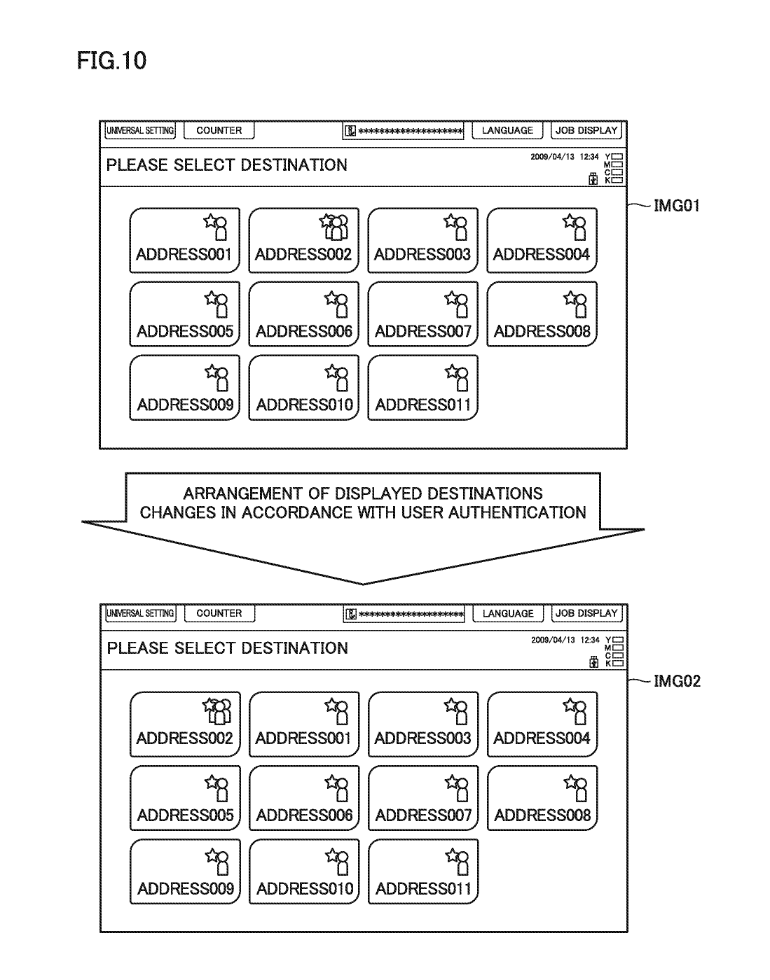

Referring further to FIG. 10, an inconvenience that occurs when display unit 320 and display unit 404 are not simultaneously visible will now be described.

An upper section of FIG. 10 shows an image IMG01 as one exemplary screen displayed on display unit 320. In image IMG01, eleven icons representing eleven addresses (“ADDRESS 001” to “ADDRESS 011”) for facsimile transmission are shown. In MFP 100, the arrangement of the eleven icons can be changed based on user authentication over short-range wireless communication. That is, the arrangement of the eleven icons can be changed to an arrangement customized to a user authenticated over short-range wireless communication.

A lower section of FIG. 10 shows an image IMG02 in which the arrangement of the icons has been changed from that shown in the upper section of FIG. 10. In image IMG02 shown in the lower section of FIG. 10, in comparison with image IMG01 shown in the upper section of FIG. 10, the position of the icon “ADDRESS 001” has been replaced with the position of the icon “ADDRESS 002”.

When display unit 320 of operation panel 300 is not readily visible to the user viewing display unit 404 of mobile terminal 400 during short-range wireless communication, the user cannot readily recognize the change in the arrangement of the icons on display unit 320.

In this respect, touch area 360 is arranged to make the display on display unit 320 more readily visible to the user viewing display unit 404 during short-range wireless communication. This allows the user to readily notice the change in the contents displayed on display unit 320, thereby smoothly proceeding with the task utilizing short-range wireless communication.

### Touch Area 360 Is Adjacent to Display Unit 320

Touch area 360 is arranged adjacent to display unit 320. Because touch area 360 is arranged near display unit 320, the user can readily visually recognize both of the display on display unit 320 and the display on display unit 404 of mobile terminal 400 when he/she waves mobile terminal 400 over touch area 360.

A user typically holds mobile terminal 400 with the right hand. In operation panel 300, touch area 360 is arranged on a right-hand side of display unit 320. This can minimize the possibility that the user's hand H holding mobile terminal 400 may touch touch sensor 350 and button group 340 despite the user's intention.

In particular, in operation panel 300, button group 340 is located on a lower side of display unit 320, and touch area 360 is located on the right-hand side of display unit 320. That is, display unit 320 is adjacent to touch area 360 on a side surface (on the right side) which is different from a side surface (on the lower side) adjacent to button group 340. Touch area 360 is thus inevitably separated from button group 340. This ensures that the user's hand H holding mobile terminal 400 is prevented from touching touch sensor 350 and button group 340 despite the user's intention.

### Touch Area 360 Is Spaced from the Start Button

Button group 340 spaced from touch area 360 includes a start button. This can minimize the possibility that the user's hand H holding mobile terminal 400 may operate the start button despite the user's intention.

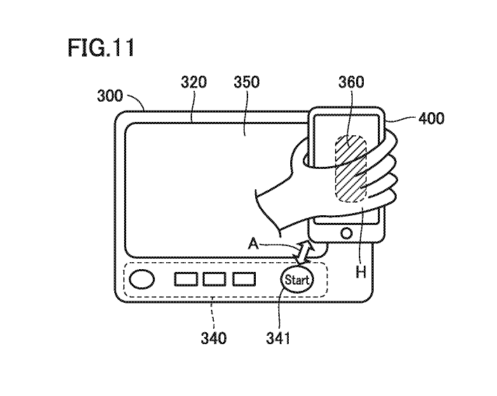

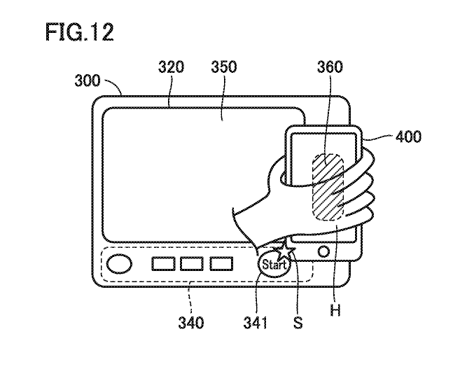

This will be more specifically described referring to FIGS. 11 and 12.

As shown in FIG. 11, button group 340 includes start button 341. In operation panel 300 shown in FIG. 11, touch area 360 is arranged in a position separated from start button 341 by a distance shown by double arrow A or longer. This reduces the possibility that mobile terminal 400 or hand H may touch start button 341 when the user's hand H waves mobile terminal 400 over touch area 360.

On the other hand, in the example shown in FIG. 12, touch area 360 is located in a position lower than that in the example shown in FIG. 11. That is, in the example shown in FIG. 12, the distance between touch area 360 and start button 341 in operation panel 300 is shorter than that in the example shown in FIG. 11.

In the example shown in FIG. 12, touch area 360 is adjacent to touch sensor 350 on the side surface different from the side surface on which start button 341 is arranged. Thus, during short-range wireless communication, any operation unintended by the user may be prevented to a certain extent. However, because touch area 360 is not sufficiently separated from start button 341, the possibility that mobile terminal 400 or hand H may touch start button 341 is considered to be higher than that in the example shown in FIG. 11, as shown by star sign S.

In operation panel 300 according to the first embodiment, touch area 360 is preferably sufficiently spaced from start button 341. This can minimize the possibility that when mobile terminal 400 is waved over touch area 360, start button 341 may be operated during short-range wireless communication despite the user's intention.

Start button 341 is one exemplary button for instructing MFP 100 to perform an irreversible operation. The irreversible operation refers to an operation in which even if an instruction to stop the operation is then issued, the operation cannot return to a state before the operation. One example of the irreversible operation is a printing operation, that is, the formation of an image onto a printing sheet. Once an image is formed on a printing sheet, even if an instruction to stop the printing operation is then issued, the printing sheet does not return to its state before the formation of the image onto the printing sheet.

The same also applies to the arrangement of the software keys on display unit 320. That is, preferably, the software keys for instructing MFP 100 to perform the irreversible operation are arranged in a place distant from touch area 360 on display unit 320.

### Arrangement of Buttons for Inputting Reversible Control Information

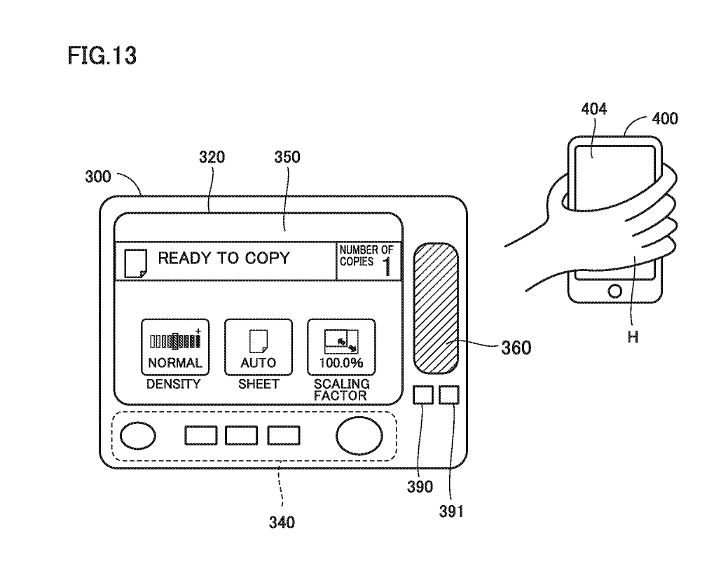

Referring to FIG. 13, a first modification of operation panel 300 according to the first embodiment will be described.

In comparison with operation panel 300 shown in FIG. 5 and the like, operation panel 300 in FIG. 13 further includes input buttons 390, 391. Input buttons 390, 391 are arranged near touch area 360. More specifically, input buttons 390, 391 are arranged on the right-hand side of touch sensor 350, as with touch area 360. Input buttons 390, 391 are exemplary buttons for inputting reversible control information.

The buttons for inputting the reversible control information may be arranged near touch area 360 in operation panel 300. One example of the reversible control information is a numerical value such as the number of copies. Another example thereof is an instruction for switching the screen to be displayed on display unit 320. Even after a numerical value such as the number of copies has been set through the input of the numerical value, this setting can be changed by canceling the input without causing MFP 100 to perform the irreversible operation. Even if the screen displayed on display unit 320 is switched in response to input of an instruction for switching the screen, the display on display unit 320 is returned to that originally displayed, by subsequently inputting information for canceling the instruction, without causing MFP 100 to perform the irreversible operation.

As described above, even if the buttons for inputting the reversible control information are operated despite the user's intention, the state of MFP 100 can be returned to its original state without any substantial damage to the user. In operation panel 300 shown in FIG. 13, the buttons for inputting the reversible control information are arranged near touch area 360, such that the buttons for instructing the irreversible operation can be more reliably arranged in a place distant from touch area 360. This can minimize damage caused by any button operation unintended by the user.

### Positional Relationship Between Touch Area 360 and Touch Sensor 350

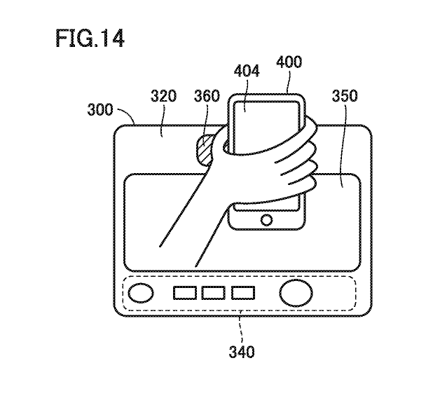

Referring to FIG. 14, a second modification of operation panel 300 according to the first embodiment will be described. In the example shown in FIG. 14, touch area 360 is arranged on an upper side of touch sensor 350.

In the example shown in FIG. 14, the possibility that the user's hand H holding mobile terminal 400 for short-range wireless communication may touch button group 340 is low. However, hand H may touch touch sensor 350 despite the user's intention, resulting in a touch in the position corresponding to a software key within display unit 320 of touch sensor 350.

As stated above, in order to more reliably prevent an unintended touch onto touch sensor 350 in operation panel 300, touch area 360 is preferably arranged adjacent to a side surface other than the upper side of touch sensor 350.

### Buttons Are Arranged Within Touch Area 360

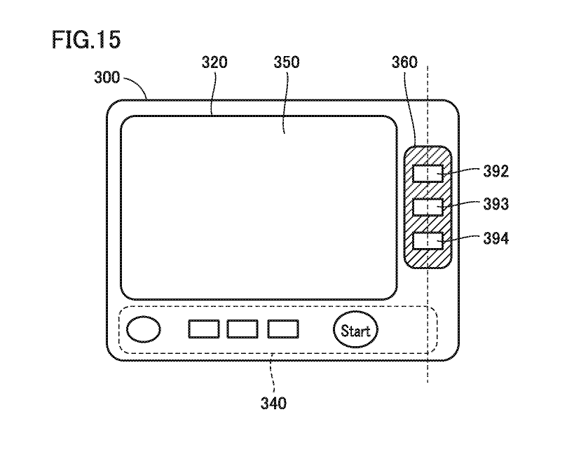

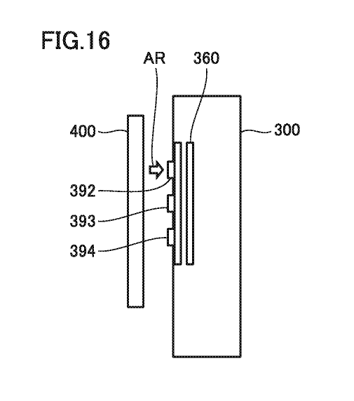

Referring to FIGS. 15 and 16, a third modification of operation panel 300 according to the first embodiment will be described. In the case of operation panel 300 shown in FIG. 15, three buttons 392, 393, and 394 for inputting information to MFP 100 are arranged within touch area 360.

In the case of operation panel 300 shown in FIGS. 15 and 16, it is very likely that mobile terminal 400 may touch at least one of buttons 392, 393, and 394 when mobile terminal 400 is waved over touch area 360. This touch may result in input of information unintended by the user to MFP 100.

It is therefore preferred that no buttons be provided within touch area 360. In this way, operation of a button unintended by the user can be more reliably prevented in operation panel 300.

### Second Embodiment

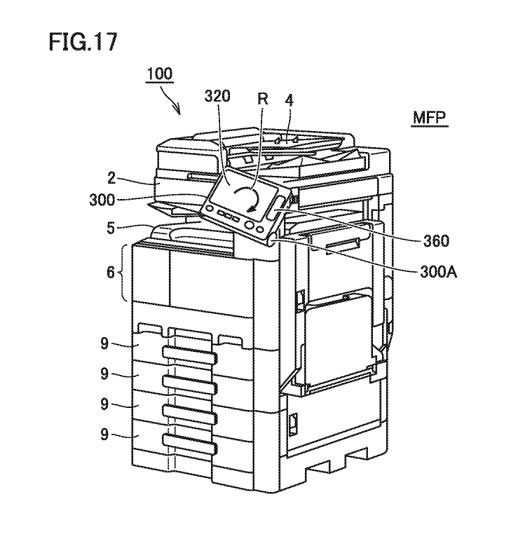

With respect to 100 according to the first embodiment, the rotation about hinge 300A (see FIGS. 2 to 4) has been shown as an example of change in the position of operation panel 300. With respect to MFP 100 according to a second embodiment, rotation within a plane in which the main face of operation panel 300 extends is shown as another example of change in the position of operation panel 300. Referring to FIG. 17, the change in the position of operation panel 300 in MFP 100 according to the second embodiment will be described.

In MFP 100 shown in FIG. 17, in comparison with MFP 100 shown in FIG. 1, operation panel 300 is fixed in a state rotated in a direction of rotation shown by arrow R. Operation panel 300 thus displays information on display unit 320 in an orientation corresponding to an orientation in which the user visually recognizes display unit 320.

Similarly, in MFP 100 according to the second embodiment, operation panel 300 is provided with touch area 360 together with display unit 320. Thus, when the position of operation panel 300 is changed, the position of mobile terminal 400 to be waved over touch area 360 can be changed in conjunction with the position of display unit 320, without the user having to take an action such as changing the arrangement of touch area 360, for example. The user can thus visually recognize the displays on both display unit 320 of operation panel 300 and display unit 404 of mobile terminal 400, without having to take an action such as changing the arrangement of touch area 360, for example.

### Third Embodiment

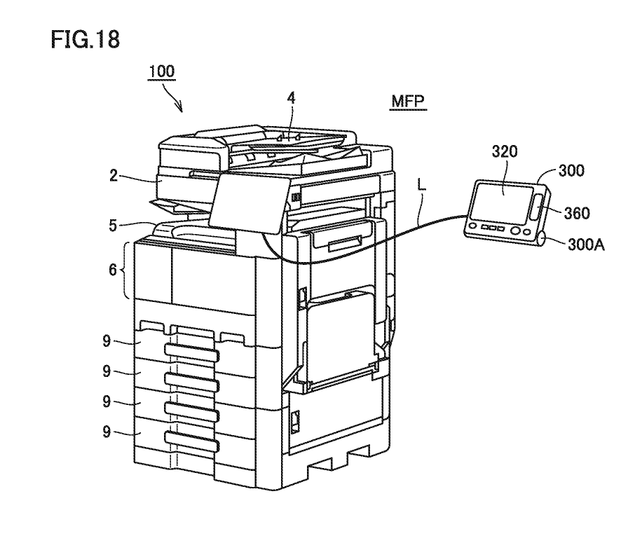

With respect to MFP 100 according to the third embodiment, a state in which operation panel 300 has been removed from the main body of MFP 100 is shown as still another example of change in the position of operation panel 300. Referring to FIG. 18, the change in the position of operation panel 300 in MFP 100 according to the third embodiment will be described.

In MFP 100 shown in FIG. 18, operation panel 300 has been removed from the main body of MFP 100. Operation panel 300 and. MFP 100 are electrically connected to each other with a cable L.

Similarly, in MFP 100 according to the third embodiment, operation panel 300 is provided with touch area 360 together with display unit 320. Touch area 360 thus moves together with display unit 320 even when operation panel 300 is removed from the main body of MFP 100. The user can thus visually recognize the displays on both display unit 320 of operation panel 300 and display unit 404 of mobile terminal 400 waved over touch area 360, without having to take an action such as changing the arrangement of touch area 360, for example.

Cable L is optional in MFP 100. That is, operation panel 300 removed from the main body of MFP 100 may be wirelessly electrically connected with the main body of MFP 100.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing apparatus capable of conducting short-range wireless communication with a terminal having a first display unit, comprising:
an operation panel including a second display unit; and
a sensor configured to sense a radio wave from the terminal for short-range wireless communication,
the operation panel capable of changing a position thereof relative to a main body of the image processing apparatus, and
the operation panel including a touch area arranged on the operation panel, the touch area being an area where the terminal is sensed by the sensor.

2. The image processing apparatus according to claim 1, wherein
execution of the short-range wireless communication involves waving of the terminal over the touch area.

3. The image processing apparatus according to claim 1, wherein
the short-range wireless communication is near field communication (NFC).

4. The image processing apparatus according to claim 1, wherein
the sensor includes an antenna disposed on a rear side of the touch area.

5. The image processing apparatus according to claim 1, wherein
the second display unit is a touch panel.

6. The image processing apparatus according to claim 1, wherein
one end of the operation panel is fixed to the main body of the image processing apparatus, and
the operation panel is configured to change the position thereof by rotating about the end.

7. The image processing apparatus according to claim 1, wherein
the operation panel is configured to be removable from the main body of the image processing apparatus.

8. The image processing apparatus according to claim 1, wherein
the touch area is arranged adjacent to the second display unit.

9. The image processing apparatus according to claim 8, wherein
the touch area is arranged adjacent to the second display unit in a portion other than an upper side of the second display unit when information is being displayed in an upright state on the second display unit.

10. The image processing apparatus according to claim 8, wherein
the operation panel includes an operation button for inputting information, and
the second display unit is adjacent to the touch area on a side surface different from a side surface adjacent to the operation button.

11. The image processing apparatus according to claim 10, wherein
the operation button includes a button for instructing the image processing apparatus to start formation of an image.

12. The image processing apparatus according to claim 10, wherein
the operation button includes a button for instructing the image processing apparatus to perform an irreversible operation.

13. The image processing apparatus according to claim 10, wherein
the touch area is arranged so as not to overlap with the operation button.

14. The image processing apparatus according to claim 1, wherein
the operation panel includes an input button for inputting reversible control information to the image processing apparatus, and
the input button is arranged near the touch area.

15. The image processing apparatus according to claim 1, wherein
the touch area is arranged adjacent to a right-hand side of the second display unit when information is being displayed in an upright state on the second display unit.

16. An image processing apparatus capable of conducting short-range wireless communication with a terminal comprising:
an operation panel including a display unit and removable from a main body of the image processing apparatus; and
a sensor configured to sense a radio wave from the terminal for short-range wireless communication,
the operation panel capable of changing a position thereof relative to a main body of the image processing apparatus, and
the operation panel including a touch area arranged on the operation panel, the touch area being an area where the terminal is sensed by the sensor.

17. The image processing apparatus according to claim 16, wherein
execution of the short-range wireless communication involves waving of the terminal over the touch area.

18. The image processing apparatus according to claim 16, wherein
the short-range wireless communication is near field communication (NFC).

19. The image processing apparatus according to claim 16, wherein
one end of the operation panel is fixed to the main body of the image processing apparatus, and
the operation panel is configured to change the position thereof by rotating about the end.

20. The image processing apparatus according to claim 16, wherein
the touch area is arranged adjacent to the second display unit.

21. The image processing apparatus according to claim 20, wherein
the operation panel includes an operation button for inputting information, and
the second display unit is adjacent to the touch area on a side surface different from a side surface adjacent to the operation button.

22. The image processing apparatus according to claim 21, wherein
the touch area is arranged so as not to overlap with the operation button.
